(19) United States
(12) Patent Application Publication
(10) Pub. No.: US 2021/0125214 A1
(43) Pub. Date: Apr. 29, 2021

(54) DIGITAL MARKETING MULTI-CHANNEL RULES ENGINE

(71) Applicant: Capital One Services, LLC, McLean, VA (US)

(72) Inventors: Gopi KANCHARLA, Frisco, TX (US); Sowjanya GURRAM, Frisco, TX (US); Padmapriya SOUNDARARAJAN, Frisco, TX (US); Praveen TANDRA, Allen, TX (US); Parvesh KUMAR, Plano, TX (US); Raman BAJAJ, Frisco, TX (US); Sanjiv YAJNIK, Dallas, TX (US); Arjun DUGAL, Dallas, TX (US); Susmitha GANGARAPU, McKinney, TX (US)

(73) Assignee: Capital One Services, LLC, McLean, VA (US)

(21) Appl. No.: 16/661,831

(22) Filed: Oct. 23, 2019

(51) Int. Cl. G06Q 30/02

(52) U.S. Cl. CPC G06Q 30/0224; G06Q 30/0239; G06Q 30/0204

(57) ABSTRACT

Various embodiments are directed to a digital marketing rules engine. In examples, the digital marketing rules engine may receive a JavaScript Object Notation (JSON) payload, one or more portions of which can be converted into a rule. The rule may be stored and registered in a cache. The rules engine may receive customer information and determine which of the numerous rules registered in the cache are applicable to the customer. The applicable rules may then be compared against the customer information to determine whether the customer should be included or excluded from an offer. If it is determined that the customer passes or meets the requirements of all the applicable rules, the offer may be provided or presented to the customer via one or more channels.

### BACKGROUND

A business rules engine may be a software system configured to execute one or more business rules in a runtime production environment. A business rule may define or constrain some aspect of business and may be intended to assert structure, control, or influence the behavior of the business. For example, the one or more rules may relate to legal regulations, company policies, or other business-related parameters. Rule engine software may commonly be provided as a component of a business rule management system, which among other functions, may provide the ability to register, define, classify, and manage the one or more rules, verify consistency of rules definitions, define the relationships between the different rules, and relate the rules to applicable information technology (IT) applications.

Typically, rules are stored, organized, or maintained statically as tabular data in spreadsheet-based or tabular-based files, such as comma-separated values (CSV) files, excel files, etc. In business marketing contexts and use-cases, however, rules may be constantly tailored, modified, or replaced based on numerous and various attributes related to customers. Thus, conventional rules engines are not equipped to handle the dynamic and fast changing nature of the rules during runtime.

### SUMMARY

Various embodiments are generally directed to a digital marketing rules engine. In examples, the digital marketing rules engine may receive a JavaScript Object Notation (JSON) payload, one or more portions of which can be converted into a rule. The rule may be stored and registered in a cache. The rules engine may receive customer information and determine which of the numerous rules registered in the cache are applicable to the customer. The applicable rules may then be compared against the customer information to determine whether the customer should be included or excluded from an offer. If it is determined that the customer passes or meets the requirements of all the applicable rules, the offer may be provided or presented to the customer via one or more channels.

### BRIEF DESCRIPTION OF THE DRAWINGS

FIG. 1 illustrates an example digital marketing rules engine in accordance with one or more embodiments.

FIG. 2 illustrates an example rule in accordance with one or more embodiments.

FIG. 3 illustrates an example feature of a rules engine analyzer in accordance with one or more embodiments.

FIG. 4 illustrates another example feature of a rules engine anlayzer in accordance with one or more embodiments.

FIG. 5 illustrates an example timing diagram in accordance with one or more embodiments.

FIG. 6 illustrates an example flow diagram in accordance with one or more embodiments.

FIG. 7 illustrates an example computing architecture of a computing device in accordance with one or more embodiments.

FIG. 8 illustrates an example communications architecture in accordance with one or more embodiments.

### DETAILED DESCRIPTION

Various embodiments are generally directed to a digital marketing rules engine configured to deliver customized marketing experiences to customers via one or more channels based on applicable rule(s). In examples, the digital marketing rules engine includes at least a rules converter for receiving a JavaScript Object Notation (JSON) payload and converting it to one or more rules, which may be stored in local memory, e.g., cache. Advantageously, the one or more rules may be specific to a customer or sets of customers. Thereafter, the rules engine may run customer information against the one or more rules and determine whether a customer is eligible for an offer. The term “offer” may be broadly understood as an offering to a customer and may include more than the product itself, such as elements that represent additional value to the customer, e.g., availability, convenience, quality of service, etc.

As described above, conventional rules are stored or maintained in a static and clunky manner (typically in databases) and are extremely difficult to modify, update, or change. The embodiments, examples, and aspects of the present disclosure overcome and are advantageous over the previous solutions in that rules are implemented via JSON transformations and not in static, tabular-based or spreadsheet-based formats. In at least that regard, rules may be built dynamically and persisted during runtime in memory. Moreover, the rules can be dynamically and instantly changed, modified, replaced, etc. during runtime. And similar to the rules, facts may be generated dynamically during runtime to be validated against one or more registered set of rules. Another advantage is that rules may be specifically tailored to the customer.

Reference is now made to the drawings, where like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form to facilitate a description thereof. The intention is to cover all modification, equivalents, and alternatives within the scope of the claims.

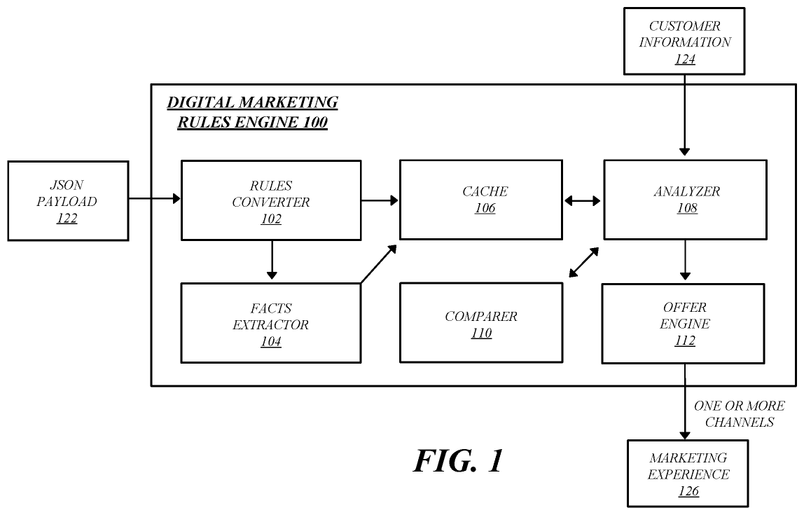

FIG. 1 illustrates an example digital marketing rules engine 100 according to embodiments. As shown, the digital marketing rules engine 100 may include at least a rules converter 102, a facts extractor 104, a cache 106, an analyzer 108, a comparer 110, and an offer engine 112. It may be understood that the rules engine 100 and the components therein may be executed, run, and/or supported by one or more computing devices. It may also be understood that one or more of the components of the digital marketing rules engine 100, for example the offer engine 112, is not required to be configured or provided within the digital marketing rules engine 100, and thus, may be provided or configured externally thereto.

In examples, the rules converter 102 may be configured to receive a JavaScript Object Notation (JSON) payload during runtime and convert one or more portions of the payload to one or more rules. For instance, the rule-conversion process may be initiated or triggered when an application programming interface (API) is made to the digital marketing rules engine 100. Thereafter (or during the same runtime), the one or more converted rules may be stored and/or registered in cache 106 or any other type of local memory. It may be understood that JSON may be an open-standard file format that uses human-readable text to transmit data objects consisting of attribute-value pairs and array data types (or any other serializable value) and may be formatted for asynchronous browser-server communication. Moreover, the term “payload” may be broadly understood to refer to any part of transmitted data that may be the actual intended message (e.g., where headers and metadata may be sent to enable payload delivery).

In further examples, the facts extractor 104 may be configured to extract one or more facts from the converted rules provided by the rules converter 102, as shown, which may then be stored and/or registered in cache 106. As will be further described below, a rule may include various types of information, one of which may be facts associated with the rule. It may be understood that a fact may assert an association between two or more terms (e.g., business term, marketing term, common term, etc.). An example fact may assert “customer with high credit scores has low risk profile.” In this example fact, the terms may include at least “customer,” “high” “credit score” (or “credit scores”), and “low risk.” Each extracted fact may be named and may hold a map of key value pairs. As further shown, the facts may also be stored in cache 106.

The cache 106 may be any suitable type of local memory, which advantageously allows registered rules, facts, marketing models, marketing offers, or any other type of information stored in the cache 106 to be easily, quickly, and/or efficiently replaced, modified, changed, altered, etc. during runtime or any predetermined number of runtimes. As illustrated, one or more components of the digital marketing rules engine 100, such as the analyzer 110, may be programmatically interfaced or communicate with the cache 106. One of the numerous advantages of implementing the cache 106 is that it is not or does not act as a conventional, static database, nor is a conventional database required. By storing the rules, facts, and other information in local memory (as opposed to statically storing data in a database), the data in the local memory can be easily and quickly changed, modified, replaced, registered, unregistered, etc. during specified runtimes.

In one embodiment, the analyzer 108 of the rules engine 100 may be configured to receive customer information 124 and perform analysis at least thereon. For example, customer information 124 may be information specific to a customer, e.g., credit score, financing history, financing terms, offered rates, accepted rates, etc. While the customer information and the rules engine in this example is explained in the financial marketing context, it may be understood that the customer information 108 can pertain to any information corresponding to the customer that allows the rules engine to determine whether the customer associated with the customer information 108 meets or satisfies one or more of the registered rules in the cache 106.

In examples, the analyzer 108 may determine whether one or more rules registered in cache 106 are applicable to the customer by matching the customer information with the facts and conditions corresponding to each registered rule. Thus, if a rule specifies that the rule is applicable when a predetermined condition is met, then the analyzer 108 may identify the rule as being applicable to the customer if the customer information satisfies or meets the predetermined condition.

Upon identifying all of the registered rules applicable to the customer, the comparer 110, which is programmatically interfaced with or communicating with the analyzer 108, may run the customer information against the applicable rule(s). If the comparer 110 (and/or the analyzer 108) determines that all of the applicable rules have been passed or satisfied, the analyzer may cause the offer engine 112 to provide one or more marketing experiences 126 (e.g., text-based ads, display ads, etc.) to the customer via one or more communication and/or marketing channels (e.g., e-mail, direct mail, messaging application, text message, mobile device-based application, web-based application, etc.).

If the comparer 110 (and/or the analyzer 108) determines that at least one rule has not been met or satisfied, the customer may be excluded from the offer and a default offer (or no offer) may be provided to the customer via the one or more channels. It may be understood that while the analyzer 108 and comparer 110 are shown in FIG. 1 as separate components of the rules engine 100, they may be integrated into a single component without limitation.

Although not shown, the digital marketing rules engine 100 may receive additional JSON payloads after receiving and processing JSON payload 122. Upon receiving the additional payloads, the rules engine 100 may convert more rules via the rules converter 102 and extract more facts via the facts extractor 104 in order to perform further analyses on the rules, facts, etc. and compare those additional rules with more customer information that may be provided to the engine 100, as described above.

One of the numerous advantages of the digital marketing rules engine 100 is that at least the rules converter 102 (solely via JSON transformations) and the cache 106 (or any other type of configured local memory) advantageously allow the rules engine 100 to maintain numerous amounts of rules and/or facts and further handle numerous amounts of customer-specific rules-based processes in a quick, efficient, and easy manner during each runtime (or a series of runtimes), which was not possible with conventional, static spreadsheet-based data or files that were stored in conventional databases.

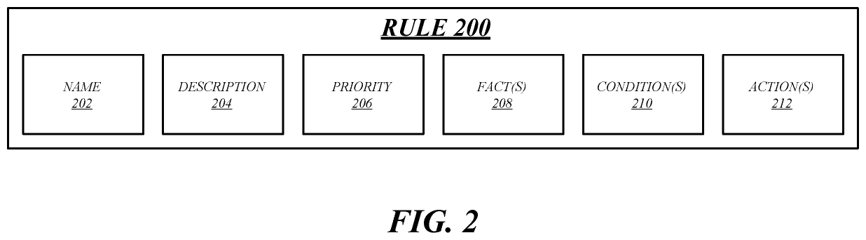

FIG. 2 illustrates an example rule 200 according to embodiments. In embodiments, rule 200 may be a rule that was converted from a JSON payload during runtime, for instance, by the rules converter 102 of the digital marketing rules engine 100 of FIG. 1.

As shown, rule 200 may include various components, such as a rule name 202, a rule description 204, priority information 206, one or more facts 208, one or more conditions 210, and one or more actions 212. It may be understood that the rule 200 shown in FIG. 2 is only an illustrative example and the configuration, arrangement, and/or the inclusion of the components therein may not be limited thereto, e.g., in some examples, the rule 200 may not include the facts 208 and may only indicate or instruct the rules engine the specific facts to access or reference when running customer information against the rule 200.

In one example, the rule name 202 may be a set of words, characters, or information that uniquely identifies or corresponds or refers to the rule 200. For instance, the rule name 202 may be defined within a rules namespace. In another example, the rule description 204 may include a short description of the rule, e.g., purpose of the rule, what the rule performs, creator of the rule, version, etc.

In yet another example, the priority information 206 may describe the priority of the rule 200 relative to other registered rules in cache. In one instance, the priority information 206 may specify that rule 200 is required to be checked against customer information prior to any other rule. As described above, the one or more facts 208 may assert one or more associations between two or more terms, where the one or more associations of the two or more terms allow the digital marketing rules engine to determine whether customer-specific information is even applicable to the rule 200.

In a further example, the one or more conditions 210 may include requirements that must be satisfied given a set of facts, e.g., the one or more facts 208, in order for the rule 200 to apply. An example of a condition may be that the customer must have been a qualified customer for at least a year or any other predefined time period. In yet a further example, the one or more actions 212 may include an action to perform when a condition, e.g., the one or more conditions 210, is satisfied. For instance, an action may be applying the rule and comparing it against the customer information. Moreover, the action may also include adding, removing, changing, modifying, etc. a registered fact in cache or even a registered rule, which will be further described below.

According to embodiments, rule 200 may be one or more different types of rules. For example, the rule 200 may be an elimination rule, which may be a rule that filters out a base population of subjects being applied to, such as customers. Thus, if the elimination rule is met or satisfied, then the customer will not be eligible for an offer. The rule 200, in another example, may be a segmentation rule, which may be a rule to determine which segment a subject may fall into. In some instances, there may be a default segment and a corresponding default offer may be provided to the customer via the one or more marketing channels if the segmentation rule is not met or satisfied. Advantageously, a rule may be customer-specific and may be tailored or customized based on a particular customer or a particular set of customers (e.g., ad-targeted customers).

According to further examples, upon converting a JSON payload to one or more rules, the rules, such as rule 200, may be registered to the digital marketing rules engine. For instance, a rule registration engine may register the one or more rules in cache. In some examples, rules that have not been registered by the rules engine cannot be used or executed. Moreover, it may be understood that rule 200 may have a rule expression, e.g., where the conditions, actions, and/or rules may be expressed in MVFLEX Expression Language (MVEL). Further, the Java datatypes associated with the rule 200 (Long, Float, etc.) may be transformed to rule specific datatypes (L, F, etc.). It may also be understood that rule 200 may have multiple operators (IN, NOT IN, NULL, etc.) and may be evaluated based on provided input.

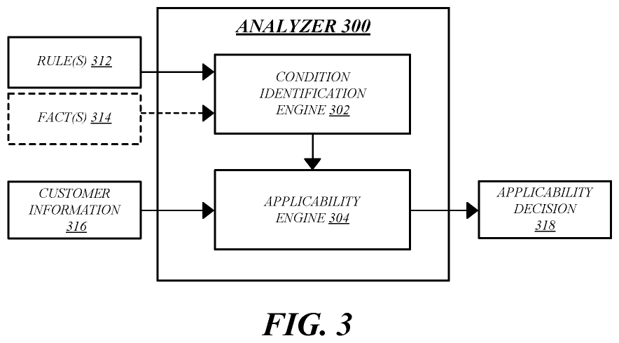

FIG. 3 illustrates an example feature of a rules engine analyzer 300 according to embodiments. The rules engine analyzer 300 may be identically or similarly configured to the analyzer 108 of the digital marketing rules engine 100 of FIG. 1. In embodiments, the example feature of FIG. 3 includes at least identifying which of the numerous rules stored and registered in cache actually applies to the customer information received by a digital marketing rules engine.

As shown, the rules engine analyzer 300 may include at least a condition identification engine 302 and an applicability engine 304. In examples, the condition identification engine 302 may be configured to receive one or more rules 312 and identify, for each of the received rules, one or more conditions that are to be satisfied for the rule to be applicable. As described above, a rule may include condition(s), which may be requirements that must be satisfied given a set of facts for the rule to be applied.

The set of facts used to determine whether the requirements of the condition(s) have been met may originate from the rule itself and/or may be provided to the condition engine 302 (e.g., one or more facts 314), as shown by the dashed box. Upon identifying the one or more conditions for each of the one or more rules 312 by the condition identification engine 302, the applicability engine 304 may receive customer information 316 and determine whether the one or more conditions for each rule have been met in order to render an applicability decision 318 for that rule.

For example, the applicability engine 304 may be configured to compare the customer information 316 against the one or more identified conditions corresponding to each of the rules(s) 312 provided by the condition identification engine 302. Based on the comparison, if the applicability engine 304 determines there is a match between at least a portion of the customer information 316 and the identified conditions, or if the customer information 316 and the identified conditions are similar up to a predetermined threshold (e.g., 90%, 95%, etc.), then the applicability engine 304 may output an applicability decision, e.g., decision 318, that indicates that one or more of the rules 312 are applicable to the customer information 316.

As described above with respect to FIG. 1, for example, the rules engine analyzer 300 may then communicate with a comparer (such as comparer 110 of FIG. 1), which compares the customer information 316 against the one or more rules 312. Thereafter, either the comparer or the analyzer 300 (or both) may determine that the customer associated with the customer information 316 is included or excluded from an offer (e.g., stored in cache) based on the comparison by the comparer.

In one example, a condition associated with a rule may be that the customer must have been a qualified customer for at least a year. Thus, if the applicability engine 304 receives customer information that indicates that the customer has been a qualified customer for four years, then that condition has been met and the rule can be compared against the customer information. For instance, the rule may be a population filter—e.g., credit scores of 600 or below are excluded from a refinancing offer.

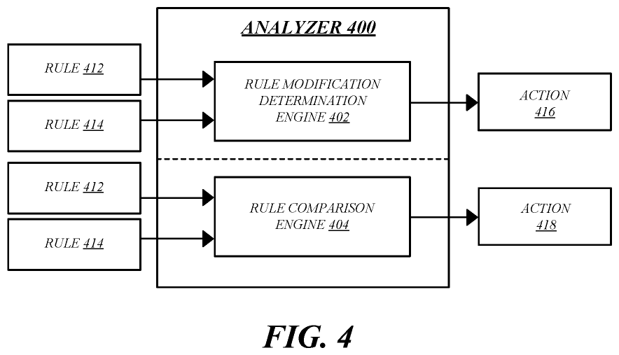

FIG. 4 illustrates another example of a feature of a rules engine analyzer 400 according to embodiments. Again, the rules engine analyzer 400 may be identically or similarly configured to the analyzer 108 of the digital marketing rules engine 100 of FIG. 1. In embodiments, the example feature of FIG. 4 includes at least analyzing subsequently received rules by the digital marketing rules engine and determining whether previously received, stored, and registered rules (or portions thereof) are to be modified, changed, replaced, deleted, or the like.

As illustrated, the rules engine analyzer 400 may include at least a rules modification determination engine 402 and a rule comparison engine 404. In one example, the rule modification determination engine 402 may receive two different rules (e.g., rules 412 and 414) at two different times (e.g., rule 412 at a first time and rule 414 at a second time later than the first time). For instance, where rule 412 was converted from a first JSON payload via a first API call at the first time, rule 414 may be converted from a second JSON payload via a second API call at the second time. When the rule modification determination engine 402 receives rule 414, it may determine whether the rule 414 includes any condition, instruction, action, etc. specifying that rule 412 be replaced with rule 414 or that the rule 412 be deleted, removed, unregistered, etc. from the cache. Based on this determination, the rule comparison engine 404 may be configured to perform an action 416 (e.g., replace rule 412 with rule 414, delete rule 412 from cache) or output instructions for performing action 416.

In another example, the rule comparison engine 404 may receive rules 412 and 414, as described above, and determine whether there are any similarities between the rules. For instance, if one or more of a name, a description, a priority, one or more facts, one or more conditions, and/or one or more actions between rules 412 and 414 are identical or are similar up to a predefined threshold (e.g., 90%, 95%, etc.), then the rule comparison engine 404 may determine that rule 412 is to be “updated,” e.g., rule 412 will be replaced with rule 414 or that rule 412 will be deleted, removed, or unregistered from the cache.

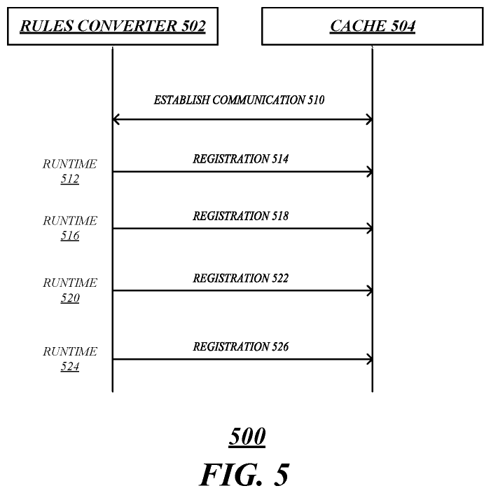

FIG. 5 illustrates an example timing diagram 500 according to embodiments. According to embodiments, the timing diagram 500 is a simplified timing sequence of the rule registration processes at different runtimes. As shown, a rules converter 502 of a digital marketing rules engine may first establish communication 510 with cache 504 (or vice versa). Simultaneously, a fact extractor (not shown) may also establish communication with the cache 504 (or vice versa).

At runtime 512, a first API call may be made to the digital marketing rules engine, during which a first JSON payload is received by the rules engine. Thereafter, the JSON payload is converted to at least a first rule by the rules converter 502, which may be registered via registration process 514 to the cache 504. As described above, a rule registration engine may be configured to register the one or more rules in the cache 504, and in some examples, rules that have not been registered by the rules engine cannot be used or executed.

Similarly, at runtime 516, a second API call may be made to the digital marketing rules engine and a second JSON payload may be received by the rules engine. The second JSON payload may then be converted to at least a second rule by the rules converter 502 and the second rule may be registered to the cache 504 via registration process 518. As described above, a rules engine analyzer may determine, during runtime 516, whether there are any instructions, indications, rules, etc. that the first registered rule should be changed, modified, altered, replaced, deleted, etc. In examples, the second rule itself may contain those instructions, or the analyzer may compare the first and second rules to determine whether the first rule is rendered moot or obsolete by the second rule (e.g., that the second rule is an “updated” version of the first rule).

Moreover, at runtimes 520 and 524, third and fourth API calls are made to the digital marketing rules engine and respective third and fourth JSON payloads may be converted to at least a third rule and a fourth rule by the rules converter 502, which may be registered to the cache 504 via registration processes 522 and 526. The rule engine analyzer may also determine whether any of the first and/or second rules are to be changed, modified, altered, replaced, deleted, etc. based on the performed analyses on the third and fourth rules.

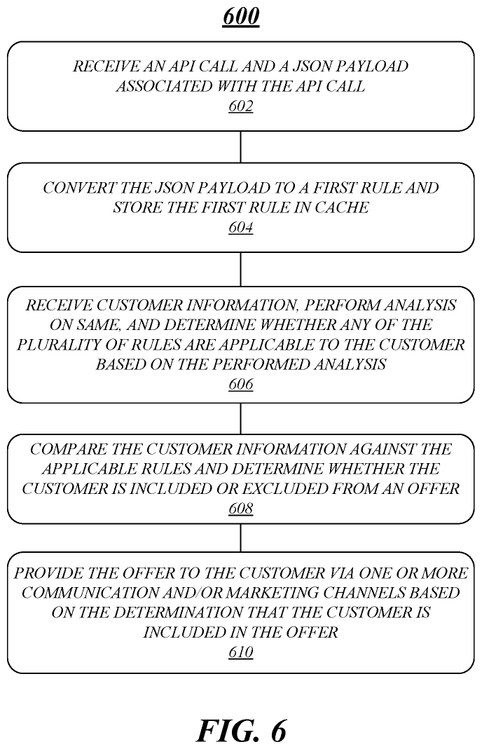

FIG. 6 illustrates an example flow diagram 600 according to one or more embodiments. It may be understood that the features associated with the illustrated blocks may be performed or executed by one or more computing devices and/or processing circuitry contained therein that can run, support, execute a digital marketing rules engine, such as the one illustrated in FIG. 1.

At block 602, an API call and a JSON payload associated with the API call may be received. As described above, the API call may correspond to a particular runtime. Additional API calls and associated JSON payloads may be received at subsequent runtimes.

At block 604, the JSON payload received at block 602 may be converted to at least a first rule, which may be stored and registered in a cache or any other suitable type of local memory during the runtime. The first rule may be one of numerous rules already stored and registered in the cache. In examples, each of the plurality of rules may contain one or more different types of information that allows the digital marketing rules engine to receive customer information and determine whether the customer should be included or excluded from a particular offer (or offers). These types of information may include the name of the rule, a description of the rule, the priority of the rule relative to other rules, one or more facts, one or more rule conditions that are required to be met in order for the rule to be applicable, one or more actions should the rule be applicable, etc. It may be understood that any of these types of information may also be extracted, stored, and/or registered in the cache at the same runtime.

At block 606, customer information associated with a customer may be received, and further, analysis on the customer information may be performed. In examples, the performed analysis may involve analyzing the numerous rules (and any associated information) stored and registered in the cache to determine which of the rules are actually relevant or applicable to the customer. For example, as set forth above, the one or more conditions for each rule may be analyzed and compared against the customer information to determine if the customer meets the requirements of the one or more conditions.

At block 608, upon determining that a certain rule (or rules) apply to the customer, the customer information may be compared against the rule or rules. Based on the comparison, it may be determined whether the customer is included or excluded from the offer. For example, a rule may a population filter, which excludes the customer if the customer has a credit score of a predefined score or below. In some examples, if it is determined that the customer is excluded from the offer, a default offer may be provided.

At block 610, upon determining that the customer has passed all of the applicable rules and should be included in the offer, the offer is provided to the customer via one or more communication and/or marketing channels. As described above, the marketing channels include e-mail, direct mail, messaging application, text message, mobile device-based application, web-based application, etc. It may be understood that an offer may be considered as any offering to a customer that includes one or more products and features directed to more than the product itself, such as elements that represent additional value to the customer, e.g., availability, convenience, quality of service, etc. Moreover, the offer may be presented in the form of a marketing experience, which includes, for example, text-based ads, display ads, etc.

In further examples, as described above, the digital marketing rules engine may receive subsequent API calls and associated JSON payloads, where the converted rules (e.g., second rule, third rule, fourth rule, etc.) may be analyzed to determine whether previously registered rules in the cache are to be modified, changed, replaced, modified, deleted, etc. Moreover, it may be understood that the blocks illustrated in FIG. 6 are not limited to any specific order and/or one or more of the blocks may be performed or executed simultaneously or near simultaneously.

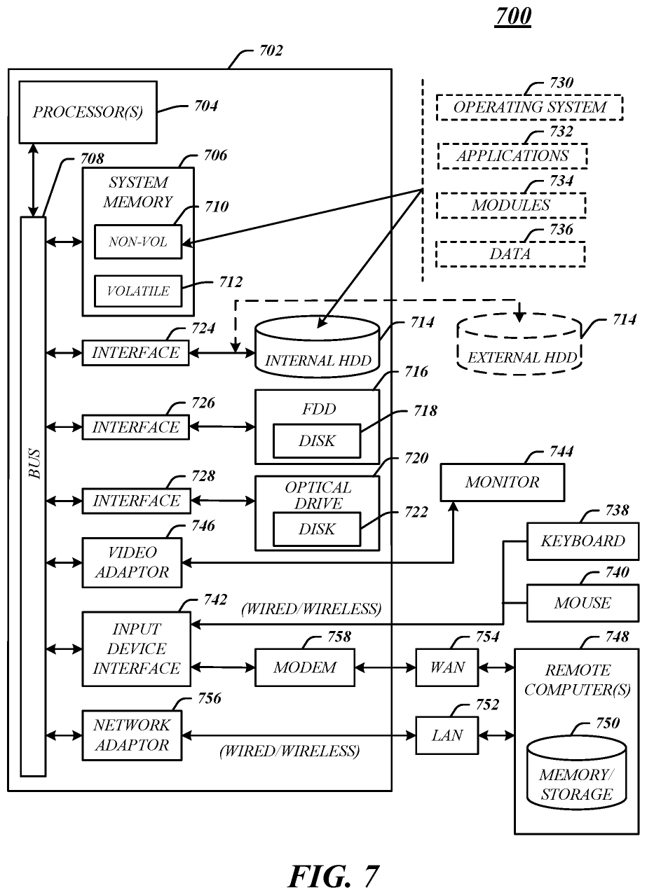

FIG. 7 illustrates an embodiment of an exemplary computing architecture 700, e.g., of a computing device, such as a desktop computer, laptop, tablet computer, mobile computer, smartphone, etc., suitable for implementing various embodiments as previously described. In one embodiment, the computing architecture 700 may include or be implemented as part of a system, which will be further described below. In examples, one or more computing devices and the processing circuitries thereof may be configured to at least run, execute, support, or provide the digital marketing rules engine, e.g., the digital marketing rules engine 100 and related functionalities.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 includes processor 704, a system memory 706 and a system bus 708. The processor 704 can be any of various commercially available processors, processing circuitry, central processing unit (CPU), a dedicated processor, a field-programmable gate array (FPGA), etc.

The system bus 708 provides an interface for system components including, but not limited to, the system memory 706 to the processor 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. In one embodiment, the one or more application programs 732, other program modules 734, and program data 736 can include, for example, the various applications and/or components of the system 800.

A user can enter commands and information into the computer 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 704 through an input device interface 742 that is coupled to the system bus 708 but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754 or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.118 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1-6 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

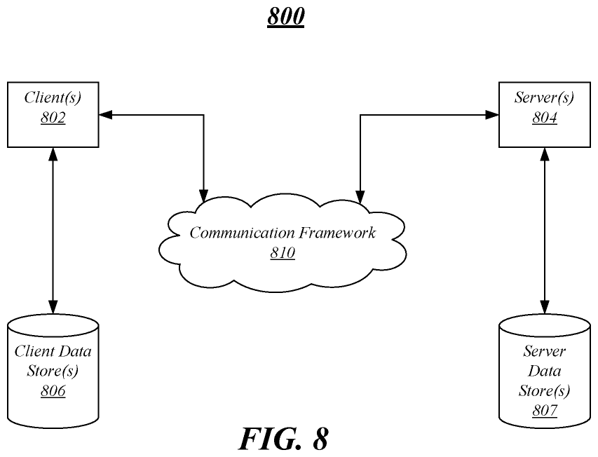

FIG. 8 is a block diagram depicting an exemplary communications architecture 800 suitable for implementing various embodiments. For example, one or more computing devices may communicate with each other via a communications framework, such as a network. At least a first computing device connected to the network may be one or more server computers, which may be implemented as a back-end server or a cloud-computing server, which may run the digital marketing rules engine described herein, e.g., rules engine 100, and perform all related functionalities. At least a second computing device connected to the network may be a user computing device, such as a mobile device (e.g., laptop, smartphone, tablet computer, etc.) or any other suitable computing device that belongs to the user. In further examples, at least the second computing device may be a computing device belonging to a customer.

The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 includes one or more clients 802 and servers 804. The one or more clients 802 and the servers 804 are operatively connected to one or more respective client data stores 806 and server data stores 807 that can be employed to store information local to the respective clients 802 and servers 804, such as cookies and/or associated contextual information.

The clients 802 and the servers 804 may communicate information between each other using a communication framework 810. The communications framework 810 may implement any well-known communications techniques and protocols. The communications framework 810 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 810 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 802 and the servers 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose and may be selectively activated or reconfigured by a computer program stored in the computer. The procedures presented herein are not inherently related to a particular computer or other apparatus. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A system comprising:
one or more computing devices, wherein the one or more computing devices comprises:
a memory to store instructions; and
processing circuitry, coupled with the memory, operable to execute the instructions, that when executed, cause the processing circuitry to:
receive a first application programming interface (API) call and a first JavaScript Object Notation (JSON) payload associated with the first API call during a first runtime;
convert the first JSON payload to at least a first rule, wherein the first rule is a first digital marking rule defining customer eligibility information related to an offer;
store and register at least the first rule in a cache during the first runtime, wherein the cache: (i) is a local memory designated to the processing circuitry and (ii) already has a plurality of rules that were stored and registered during prior runtimes previous to the first runtime, and wherein the plurality of rules are modifiable, replaceable, or removable in the cache during the first runtime by the first rule;
receive a second API call and a second JSON payload associated with the second API call during a second runtime subsequent to the first runtime;
convert the second JSON payload to at least a second rule, the second rule being different from the first rule and is second digital marking rule related to the offer;
determine, during the second runtime, whether the first rule is to be modified or replaced based on the second rule;
in response to the determination that the first rule is to be modified or replaced, modify or replace the first rule with the second rule in the cache during the second runtime;
receive information associated with a customer and determine whether the customer is included or excluded from the offer based on a comparison of the information against the second rule; and
provide, based on the determination that the customer is included in the offer, the offer to the customer via one or more communication channels.

2. The system of claim 1, wherein the processing circuitry is further caused to:
provide, based on the determination that the customer is excluded from the offer, (i) a default offer to the customer via the one or more communication channels or (ii) no offer.

3. The system of claim 1, wherein the processing circuitry is further caused to:
store and register the second rule in the cache during a second runtime.

4. The system of claim 1, wherein first rule comprises one or more of the following information: (i) a rule name, (ii) a description of the rule, (iii) priority of the rule with respect to other rules, (iv) one or more facts, (v) one or more conditions for the rule to be applicable, and (vi) one or more actions performed when the one or more conditions are met or satisfied, the one or more actions including adding, removing, or modifying the one or more facts.

5. The system of claim 4, wherein the processing circuitry is further caused to extract the one or more facts from the first JSON payload.

6. The system of claim 1, wherein the first rule is an elimination rule, the elimination rule excluding the customer from the offer when the elimination rule is satisfied.

7. The system of claim 1, wherein the first rule is a segmentation rule, the segmentation rule categorizes the customer into one or more segments.

8. The system of claim 7, wherein the one or more segments includes a default segment, and the processing circuitry is further caused to:
determine whether the customer is categorized in the default segment;
determine that the customer is excluded from the offer based on the determination that the customer is categorized in the default segment; and
provide the customer a default offer via the one or more communication channels.

9. The system of claim 1, wherein the analysis performed on the information and first rule comprises the processing circuitry being further caused to:
identify, in the first rule, one or more conditions to be satisfied for the first rule to be applicable, wherein the one or more conditions are included in the first rule; and
compare the information associated with the customer against the one or more conditions of the first rule to determine whether the customer is eligible for the offer.

10. The system of claim 3, wherein the analysis performed on the second rule comprises the processing circuitry being further to:
determine whether the second rule includes a condition, an instruction, or an action specifying (i) the first rule be replaced with the second rule or (ii) the first rule be deleted or removed from the cache.

11. The system of claim 3, wherein the analysis performed on the second rule comprises the processing circuitry being further to:
determine whether one or more of the following: a name, a description, a priority, one or more facts, one or more conditions, and one or more actions of the first rule and one or more of the following: a name, a description, a priority, one or more facts, one or more conditions, and one or more actions of the second rule are identical or similar up to a predefined threshold; and
(i) replace the first rule with the second rule or (ii) delete or remove the first rule from the cache based on the determination that the first rule and the second rule are identical or similar up to the predefined threshold.

12. The system of claim 1, wherein the first rule is customer-specific.

13. The system of claim 1, wherein the first rule and the plurality of rules are not stored in database format in the cache and in a datastore.

14. A method comprising:
receiving a first application programming interface (API) call and a first JavaScript Object Notation (JSON) payload associated with the first API call during a first runtime;
converting, via at least one processor, the first JSON payload to at least a first rule, wherein the first rule is a first digital marking rule defining customer eligibility information related to an offer;
storing and registering, via the at least one processor, at least the first rule in a cache during the first runtime, wherein the cache: (i) is a local memory designated to the processing circuitry and (ii) already has a plurality of rules that were stored and registered during prior runtimes previous to the first runtime, and wherein the plurality of rules are modifiable, replaceable, or removable in the cache during the first runtime by the first rule;
receiving a second API call and a second JSON payload associated with the second API call during a second runtime subsequent to the first runtime;
converting, via the at least one processor, the second JSON payload to at least a second rule, the second rule being different from the first rule and is second digital marking rule related to the offer;
determining, via the at least one processor, whether the first rule is to be modified or replaced based on the second rule during the second runtime;
in response to the determining that the first rule is to be modified or replaced, modifying or replacing, via the at least one processor, the first rule with the second rule in the cache during the second runtime;
receiving information associated with a customer and determining, via the at least one processor, whether the customer is included or excluded from the offer based on a comparison of the information against the second rule; and
providing, via the at least one processor, the offer to the customer via one or more communication channels based on the determining that the customer is included in the offer.

15. The method of claim 14, wherein the cache is updated, refreshed, or reloaded at a predefined interval.

16. The method of claim 14, wherein the first rule is an elimination rule, the elimination rule excluding the customer from the offer when the elimination rule is satisfied.

17. The method of claim 14, wherein the first rule is a segmentation rule, the segmentation rule categorizes the customer into one or more segments.

18. The method of claim 14, further comprising providing a default offer or no offer to the customer based on the determination.

19. A non-transitory computer-readable storage medium storing computer-readable program code executable by a processor to:
receive a first application programming interface (API) call and a first JavaScript Object Notation (JSON) payload associated with the first API call during a first runtime;
convert the first JSON payload to at least a first rule, wherein the first rule is a first digital marking rule defining customer eligibility information related to an offer;
store and register at least the first rule in a cache during the first runtime, wherein the cache: (i) is a local memory designated to the processing circuitry and (ii) already has a plurality of rules that were stored and registered during prior runtimes previous to the first runtime, and wherein the plurality of rules are modifiable, replaceable, or removable in the cache during the first runtime by the first rule;
receive a second API call and a second JSON payload associated with the second API call during a second runtime subsequent to the first runtime;
convert the second JSON payload to at least a second rule, the second rule being different from the first rule and is second digital marking rule related to the offer;
determine, during the second runtime, whether the first rule is to be modified or replaced based on the second rule;
in response to the determination that the first rule is to be modified or replaced, modify or replace the first rule with the second rule in the cache during the second runtime;
receive information associated with a customer and determine whether the customer is included or excluded from the offer based on a comparison of the information against the second rule; and
provide, based on the determination that the customer is included in the offer, the offer to the customer via one or more communication channels.

20. The non-transitory computer-readable storage medium of claim 18, wherein the first rule is an elimination rule and/or a segmentation rule, the elimination rule excluding the customer from the offer when the elimination rule is satisfied, and the segmentation rule categorizes the customer into one or more segments.
